(19) United States
(12) Patent Application Publication
(10) Pub. No.: US 2021/0295832 A1
(43) Pub. Date: Sep. 23, 2021

(54) VOICE CONTROL OF PC THROUGH INVOCATION OF APP- OR MODE-SPECIFIC TRIGGER WORDS

(71) Applicant: Lenovo (Singapore) Pte. Ltd., Singapore (SG)

(72) Inventors: Lincoln P. Hancock, Raleigh, NC (US); Aaron M. Stewart, Raleigh, NC (US)

(21) Appl. No.: 16/821,029

(22) Filed: Mar. 17, 2020

(51) Int. Cl. G10L 15/22; G06N 5/02; G10L 15/06; G10L 15/18

(52) U.S. Cl. CPC G10L 15/22; G06N 5/02; G10L 2015/228; G10L 15/18; G10L 2015/223; G10L 15/063

(57) ABSTRACT

An approach is provided that receives, at a microphone, a voice command from the user of an information handling system. A selected software application is identified from any number of software applications based on the received voice command. The received voice command is then directed to the identified software application.

### BACKGROUND

Currently, voice interaction on personal computing devices does not support many basic operations and commands within programs. Digital assistants are often oblivious to the user's context and active application environment. Voice control on personal computing devices largely falls into one of two types of interactions. These types of interactions are either inquiry and requests using a digital assistant or speech recognition dictation software and applications.

Digital assistant interaction typically uses a keyword or button-press trigger to invoke the digital assistant to listen to a command and respond accordingly. Dictation, on the other hand, is generally triggered through a graphic user interface (GUI) or as a second-level function of the resident digital assistant. During dictation, words that are spoken are recognized by the software, converted to text, and reproduced on the screen. Some dictation tools incorporate basic formatting controls. Neither of these modes of voice interaction conveys provides the core types of personal computing use as performed by a user using standard touch, keyboard, and point-and-click methods to control the computing device. With digital assistants, the invocation process can add a clunky barrier to a basic command sequence. Additionally, digital assistants are not attuned to fundamental cues regarding a user's activity other than dictation. The resulting experience diminishes the perceived utility of voice on personal computing devices. While the digital assistant offers value, it requires trigger words or actions and largely controls digital assistant-based apps and functions. While dictation software is useful in converting speech to text, it is hyper-focused and constrained to the dictation environment.

### SUMMARY

An approach is provided that receives, at a microphone, a voice command from the user of an information handling system. A selected software application is identified from any number of software applications based on the received voice command. The received voice command is then directed to the identified software application.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram depicting the components used in voice control of an information handling system using application specific trigger words;

FIG. 4 is a flowchart showing steps taken by a process that performs setup operations at an information handling system that uses voice control using application specific trigger words;

FIG. 5 is a flowchart showing steps taken by a process that uses application specific trigger words to direct voice input to an identified software application; and

FIG. 6 is a flowchart showing steps taken by a process that handles incoming vocal application commands.

### DETAILED DESCRIPTION

The figures show an approach that gives users a more practical and essential channel for voice interaction with a computing device. The approach works in a wide array of common usage scenarios, such as a user utilizing shortcuts, toolbar commands, basic desktop activities, and the like through voice control. The approach identifies the software application to which the voice command is directed. In one embodiment, the approach identifies the software application based on the command that is given. For example, a command to format a paragraph might be directed to a word processing application rather than a spreadsheet application, while a command referencing a range of cells might be directed to the spreadsheet application instead of the word processing application.

In one embodiment, a distance of the user from the information handling system can be used to determine either a software application or a mode of operation of a particular application. For example, if the user is some distance from the information handling system, say thirty feet, and gives a command to “display the next page” while having a word processing and a presentation application running, then the command might be directed to the presentation application because the user is not proximate to the information handling system. On the other hand, if the user is close to the information handling system, say three feet, then the same command might be directed to the word processing application, especially if the word processing application currently has focus.

In one embodiment, the user's current distance from the information handling system can be used to determine the operating mode of the application. For example, if a presentation application is currently running and the user is thirty feet away from the information handling system, then the operating mode of the application might be directed to the presentation application in “presentation mode,” however if the user is much closer to the information handling system, say three feet, then the same command might be directed to the presentation application in “design mode.”

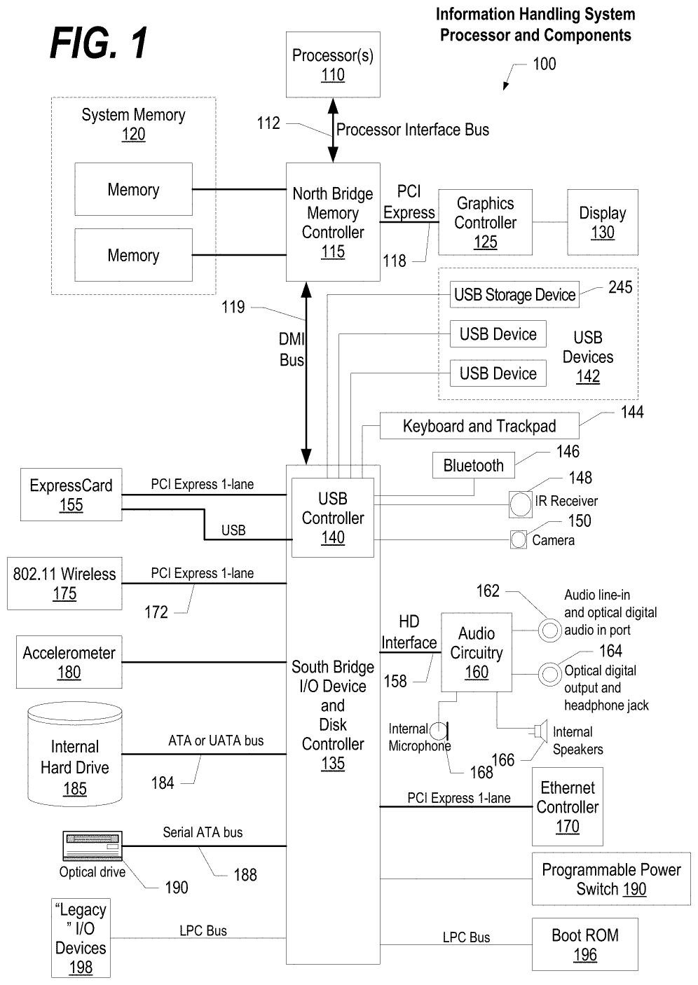

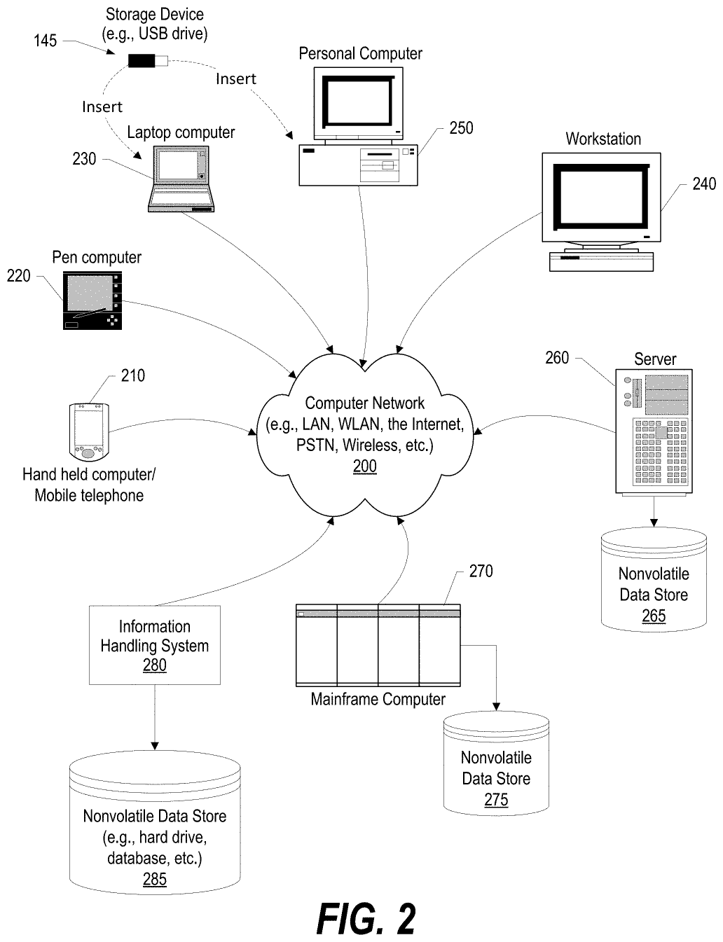

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a device that is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Accelerometer 180 connects to Southbridge 135 and measures the acceleration, or movement, of the device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may be a device that can take many forms. For example, an information handling system may take the form of a desktop device, server device, portable device, laptop device, notebook device, or other form factor device. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of devices that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling system devices include pen, or tablet, device 220, laptop, or notebook, device 230, workstation device 240, personal computer system device 250, and server device 260. Other types of information handling system devices that are not individually shown in FIG. 2 are represented by information handling system device 280. As shown, the various information handling system devices can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

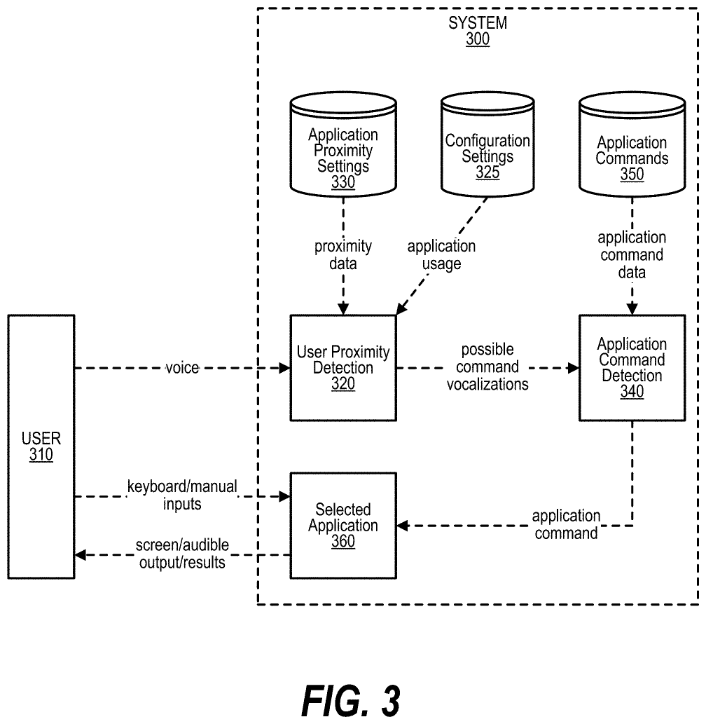

FIG. 3 is a component diagram depicting the components used in voice control of an information handling system using application specific trigger words. System 300 runs on an information handling system of an architecture such as that shown in FIG. 1 and on a type of system such as any of the types of information handling systems shown in FIG. 2. Data stores shown in FIG. 3 are stored on a memory, such as a nonvolatile storage device or volatile or nonvolatile memory, examples of which are shown in FIG. 1. Applications and routines are stored in such memories and executed by the processor, or processors, included in the information handling system.

User 310 speaks voice commands that are input to the system using a microphone. The voice commands are processed by user proximity detection process 320. This process utilizes application proximity settings retrieved from data store 330 and configuration settings that are retrieved from data store 325. The proximity of the user from the information handling system might be determined based on the user's vocal quality (e.g., speaking from a distance, etc.) and can also be determined based on other sensors, such as digital cameras and motion detection devices that can determine the user's distance from the information handling system. The application proximity settings determines the approximate distance (proximity) of the user from various applications so that such commands are directed to those applications. In addition, the proximity of the user from the applications can be used to determine an operating mode of the application to process the command. For example, using a “presentation mode” of operation when the user is some distance from the information handling system, and using a “design mode” of operation when the user is near the information handling system. The configuration settings identify applications that the user wishes to utilize voice commands. In one embodiment, the user can choose to have “all applications” use voice commands input by the user.

The result of process 320 is possible command vocalizations that are converted to textual strings and provided to application command detection process 340 that compares the possible command vocalizations to application commands available in the set of applications running on the information handling system. The application command data is retrieved from data store 350. In one embodiment, the operating system can receive the voice input to open additional applications and close applications that are currently running. The identified command is then directed to application 360 with this application having been selected, or identified, by the command and, in some cases, the user's proximity to the information handling system. As shown, the user can of course provide traditional keyboard and manual inputs to the selected application. The user receives visual (screen) and possibly audible outputs or results from the input of the voice command to application 360.

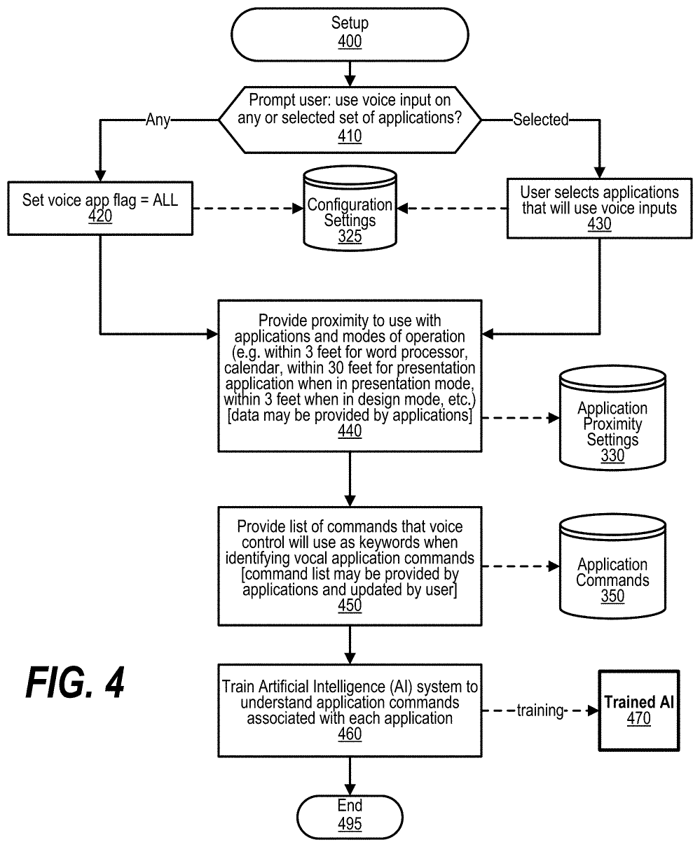

FIG. 4 is a flowchart showing steps taken by a process that performs setup operations at an information handling system that uses voice control using application specific trigger words. FIG. 4 processing commences at 400 and shows the steps taken by a setup process that is used to configure the usage of voice commands to applications that run on the user's information handling system.

The process determines, based on the user's response to a prompt, as to whether the user wishes to use voice input on any application or only on a selected set of applications (decision 410). If the user wishes to use voice input on any application, then decision 410 branches to the ‘any’ branch whereupon, at step 420, the voice application flag is set to ‘all’ and this setting is stored in configuration data store 325. On the other hand, if the user wishes to use voice input only on a selected set of applications, then decision 410 branches to the ‘selected’ branch whereupon, at step 430, the process has the user select those applications that the user wants to use voice inputs. The identifiers of applications selected by the user are then stored in configuration data store 325.

At step 440, the process provides a proximity to use with applications and modes of operation of such applications. For example, within three feet for a word processor or calendar application. Within thirty feet for a presentation application when in the application is in presentation mode and within three feet when in the application is in design mode, etc. In one embodiment, such proximity data may be provided by the various applications in lieu of, or in addition to, having such data provided by the user. This proximity data is stored in data store 330.

At step 450, the process provides a list of commands that voice control will use as keywords when identifying vocal application commands for the various applications. This list of commands is stored in data store 350. Likewise, such command list data may be provided by various applications in lieu of or in addition to user entry and such data can be updated by user to meet user preferences.

At step 460, the process trains an Artificial Intelligence (AI) system to understand the various application commands associated with each application. This results in a trained AI 470 that can be utilized by the voice command system to identify applications and application operation modes utilized by such applications. FIG. 4 processing depicting setup operations thereafter ends at 495.

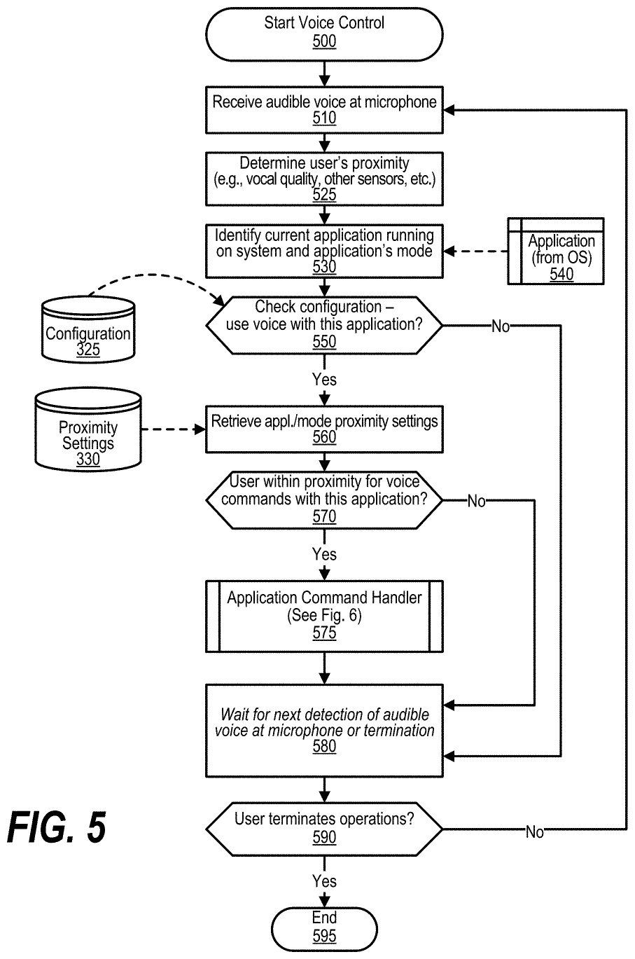

FIG. 5 is a flowchart showing steps taken by a process that uses application specific trigger words to direct voice input to an identified software application. FIG. 5 processing commences at 500 and shows the steps taken by a process that processes voice control commands received at the information handling system. At step 510, the process receives the user's audible voice at a microphone that is connected to the information handling system. At step 525, the process determines the user's proximity. The user's proximity can be determined based on the user's vocal quality or using other sensors, such as digital camera and/or motion detectors, to determine the user's proximity to the information handling system.

At step 530, the process identifies the current applications running on the system and the current operating mode of the applications (e.g., presentation mode, design mode, etc.). In one embodiment, the list of current applications are received from operating system 540 that is running on the information handling system. At decision 550, the process checks the configuration established by the user and retrieved from data store 325 to determine whether to use voice commands with the current application. If voice commands are being used with the application, then decision 550 branches to ‘yes’ branch for further processing. On the other hand, if voice commands are not used with this application, then decision 550 branches to ‘no’ branch bypassing steps 560 through 575.

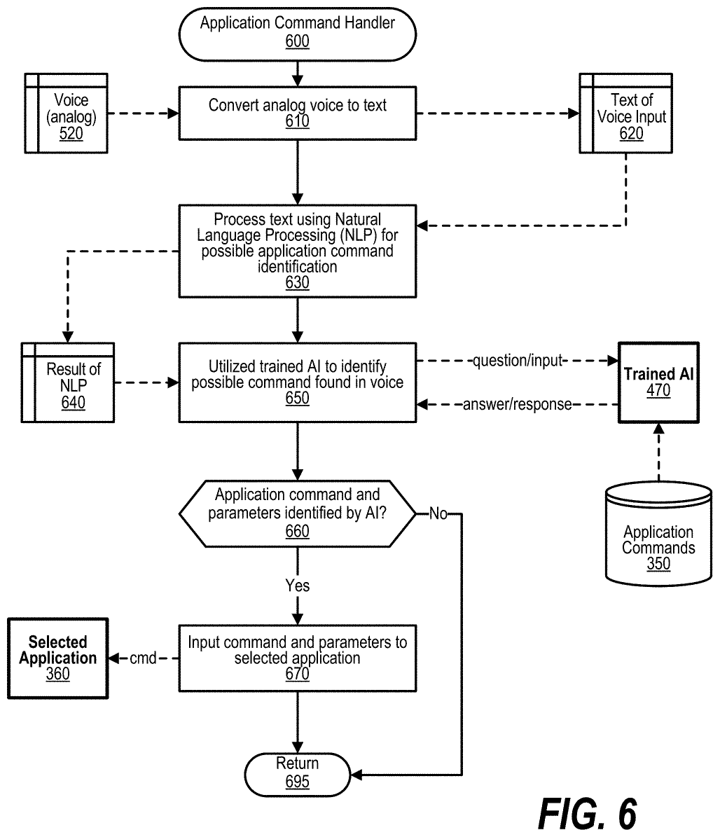

At step 560, the process retrieves the application and mode proximity settings from data store 330. The process determines as to whether the user is within established proximity settings for using voice commands with this application (decision 570). If the user is within established proximity settings for using voice commands with this application, then decision 570 branches to the ‘yes’ branch whereupon, at predefined process 575, the process performs the Application Command Handler routine (see FIG. 6 and corresponding text for details). On the other hand, if the user is not within established proximity settings for using voice commands with this application, then decision 570 branches to the ‘no’ branch bypassing predefined process 575.

At step 580, the process waits for the next detection of an audible voice to be received at the microphone or for the user to terminate the process. The process determines as to whether the user has terminated the process (decision 590). If the user has terminated the process, then decision 590 branches to the ‘yes’ branch and processing ends at 595. On the other hand, if the user has not terminated the process, then decision 590 branches to the ‘no’ branch whereupon processing loops back to step 510 to receive and process the next audible voice received from the user.

FIG. 6 is a flowchart showing steps taken by a process that handles incoming vocal application commands. FIG. 6 processing commences at 600 and shows the steps taken by an application command handler routine. At step 610, the process converts the analog voice received at the microphone from microphone's memory area 520 to a textual form that is stored in memory area 620.

At step 630, the process uses Natural Language Processing (NLP) to process the text input from memory area 620 for possible application command identification with the NLP results being stored in memory area 640. At step 650, the process utilizes trained AI system 470 to identify any possible command that might be found in the voice input. In one embodiment, the process transmits the NLP results to trained AI system 470 that has previously been trained with application commands corresponding to applications used by the user. The trained AI then identifies any possible commands and returns a response to the process indicating any command that was found.

The process determines as to whether any application command and parameters associated with the command were identified by the AI system (decision 660). If any application command and parameters associated with the command were identified by the AI system, then decision 660 branches to the ‘yes’ branch whereupon, at step 670, the process inputs the identified command and any associated parameters to selected application 360. In one embodiment, the command is sent to the current application, while in another embodiment, the application to which the command is associated is also identified and selected with the command being input to such selected application. On the other hand, if a command was not identified by the AI system, then decision 660 branches to the ‘no’ branch bypassing step 670. FIG. 6 processing thereafter returns to the calling routine (see FIG. 5) at 695.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. As used herein, a computer readable storage medium does not include a transitory signal.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While particular embodiments have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to others containing only one such element, even when the same claim includes the introductory phrases “one or more” or “at least one” and indefinite articles such as “a” or “an”; the same holds true for the use in the claims of definite articles.

What is claimed is:

1. A method, implemented by an information handling system comprising a processor, a memory accessible by the processor, and a microphone that receives voice input from a user, the method comprising:
receiving a voice command from the user;
identifying a selected software application from a plurality of software applications based on the received voice command; and
directing the received voice command to the identified software application.

2. The method of claim 1 wherein the identifying further comprises:
determining a distance between the user and the information handling system, wherein the identification of the of the selected software application is based on a proximity of the user to the information handling system.

3. The method of claim 1 further comprising:
determining a distance between the user and the information handling system;
selecting an operation mode of the selected software application based on a proximity of the user to the information handling system; and
further directing the identified software application to perform the received voice command in the selected operation mode.

4. The method of claim 1 further comprising:
prior to receiving the voice command from the user, training an artificial intelligence (AI) system with a plurality of voice commands corresponding to the plurality of software applications, wherein the plurality of voice commands includes the received voice command and wherein the plurality of software applications includes the selected software application.

5. The method of claim 4 further comprising:
converting the received voice command to a textual form using Natural Language Processing (NLP).

6. The method of claim 5 further comprising:
inputting the textual form to the trained AI system; and
receiving a response from the AI system, wherein the response identifies the selected software application.

7. The method of claim 4 further comprising:
receiving a list of commands corresponding to each of the plurality of software applications; and
training the AI system using the received list of commands pertaining to each of the plurality of software applications.

8. An information handling system comprising:
one or more processors;
a memory coupled to at least one of the processors;
a microphone that receives voice input from a user of the information handling system, wherein the microphone is accessible by at least one of the processors; and
a set of computer program instructions stored in the memory and executed by at least one of the processors in order to perform actions comprising:
receiving, at the microphone, a voice command from the user;
identifying a selected software application from a plurality of software applications based on the received voice command; and
directing the received voice command to the identified software application.

9. The information handling system of claim 8 wherein the identifying further comprises:
determining a distance between the user and the information handling system, wherein the identification of the of the selected software application is based on a proximity of the user to the information handling system.

10. The information handling system of claim 8 further comprising:
determining a distance between the user and the information handling system;
selecting an operation mode of the selected software application based on a proximity of the user to the information handling system; and
further directing the identified software application to perform the received voice command in the selected operation mode.

11. The information handling system of claim 8 further comprising:
prior to receiving the voice command from the user, training an artificial intelligence (AI) system with a plurality of voice commands corresponding to the plurality of software applications, wherein the plurality of voice commands includes the received voice command and wherein the plurality of software applications includes the selected software application.

12. The information handling system of claim 11 further comprising:
converting the received voice command to a textual form using Natural Language Processing (NLP).

13. The information handling system of claim 12 further comprising:
inputting the textual form to the trained AI system; and
receiving a response from the AI system, wherein the response identifies the selected software application.

14. The information handling system of claim 11 further comprising:
receiving a list of commands corresponding to each of the plurality of software applications; and
training the AI system using the received list of commands pertaining to each of the plurality of software applications.

15. A computer program product comprising:
a computer readable storage medium, comprising computer program code that, when executed by an information handling system, executes actions comprising:
receiving a voice command from a user;
identifying a selected software application from a plurality of software applications based on the received voice command; and
directing the received voice command to the identified software application.

16. The computer program product of claim 15 wherein the identifying further comprises:
determining a distance between the user and the information handling system, wherein the identification of the of the selected software application is based on a proximity of the user to the information handling system.

17. The computer program product of claim 15 further comprising:
determining a distance between the user and the information handling system;
selecting an operation mode of the selected software application based on a proximity of the user to the information handling system; and
further directing the identified software application to perform the received voice command in the selected operation mode.

18. The computer program product of claim 15 further comprising:
prior to receiving the voice command from the user, training an artificial intelligence (AI) system with a plurality of voice commands corresponding to the plurality of software applications, wherein the plurality of voice commands includes the received voice command and wherein the plurality of software applications includes the selected software application.

19. The computer program product of claim 18 further comprising:
converting the received voice command to a textual form using Natural Language Processing (NLP).

20. The computer program product of claim 19 further comprising:
inputting the textual form to the trained AI system; and
receiving a response from the AI system, wherein the response identifies the selected software application.
